(19) United States
(12) Patent Application Publication
(10) Pub. No.: US 2009/0328036 A1
(43) Pub. Date: Dec. 31, 2009

(54) SELECTION OF VIRTUAL COMPUTING RESOURCES USING HARDWARE MODEL PRESENTATIONS

(75) Inventor: Jonathan Betts-LaCroix, San Francisco, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/163,940

(22) Filed: Jun. 27, 2008

(51) Int. Cl. G06F 9/455

(52) U.S. Cl. 718/1

(57) ABSTRACT

A user can configure and purchase virtual computing resources in much the same way buyers now configure and purchase physical computers. One embodiment allows a user to select various performance parameters that are commonly known and used by the average user of a personal computer. For example, a baseline computer system can be selected and then customized by choosing performance parameter such as a processor brand name, processor clock speed, random-access memory (RAM) capacity, hard disk drive capacity, etc. The performance parameters can then be used to configure virtual computing resources to achieve a virtual computer that substantially meets the performance parameters.

### REFERENCE TO RELATED APPLICATIONS

This application is related to the following co-pending patent applications which are each hereby incorporated by reference as if set forth in full in this specification for all purposes:

1. U.S. patent application Ser. No. ______ [TBD] entitled “COMPUTING WITH LOCAL AND REMOTE RESOURCES INCLUDING USER MODE CONTROL,” filed on Jun. 27, 2008 (Attorney docket numbers 100127-002800US and OQO/COM0607S); and

2. U.S. patent application Ser. No. ______ [TBD] entitled “COMPUTING WITH LOCAL AND REMOTE RESOURCES USING AUTOMATED OPTIMIZATION,” filed on Jun. 27, 2008 (Attorney docket numbers OQO/COM0438S and 100127-003200US).

### BACKGROUND

One typical approach to computing provides a user with a dedicated, local computer system. The local computer system can include local computing resources such as processing power, storage capacity, bandwidth for data transfers, output capability (e.g, display, audio speakers, etc.), input capability (e.g., keyboard, mouse, touch screen, camera, gesture recognition, etc.), and other resources. The user has control over the local computer system and the local computer system's resources in order to perform desired functions to achieve desired results. For example, a user can use the local computing resources to search and display information, run simulations; create documents, process images, play or edit video or audio content, send messages, play games, or to perform many other tasks.

In some cases a user may wish to use “virtual” computing resources that are not part of a local computer system. Virtual computing resources can include any of the same types of resources that are available in a dedicated machine, such as a local computer, but the virtual computing resources are generally available in much larger quantities and varieties than in most dedicated or user-owned computers. The virtual computing resources are typically maintained by a different entity that is not under the user's ownership or control. For example, a company may operate dozens or hundreds of remote computers that include the ability to provide many times the amount of processing power, storage capacity, bandwidth or other resources that a user may desire. So a user may benefit from using virtual computing resources to achieve greater, or different, processing power than they might otherwise be able to economically or practicably obtain. Other advantages of virtual computing resources include allowing a user to “lease” or “buy” virtual computing resources on an as-needed basis. The as-needed basis can vary by time, according to a particular function or task to be performed, or according to other conditions.

A user may find it difficult to purchase or obtain virtual computing resources. Most of today's computer users are not familiar with virtual computing resources. On the other hand, most of today's users are very familiar with comparing and purchasing dedicated computing resources. Because of this, a user may not be able to determine a selection and arrangement of virtual computing resources that can efficiently perform a desired task, such as running a particular software application. Also, it may be confusing for a user to recognize when it may be advantageous to purchase virtual computing resources as opposed to dedicated computing resources since no readily-available utilities exist to compare the two different computing approaches.

### SUMMARY

Embodiments of the invention allow a user to configure and purchase virtual computing resources in much the same way buyers now configure and purchase dedicated computers. One embodiment presents the performance of a virtual computer with the same performance parameters that are commonly known and used by the average user of a personal computer. For example, processor brand name (i.e., Intel “Pentium™,” Advanced Micro Devices (AMD) “Duron™,” etc.), processor clock speed, random-access memory (RAM) capacity, hard disk drive capacity, motherboard bus speeds, graphics card type, graphics card memory, etc., are each computer performance parameters that can be used to determine a particular selection of virtual computing resources.

A user can configure and purchase virtual computing resources in much the same way buyers now configure and purchase physical computers. One embodiment allows a user to select various performance parameters that are commonly known and used by the average user of a personal computer. For example, a baseline computer system can be selected and then customized by choosing performance parameter such as a processor brand name (i.e., Intel “Pentium™,” Advanced Micro Devices (AMD) “Duron™,” etc.), processor clock speed, random-access memory (RAM) capacity, hard disk drive capacity, motherboard bus speeds, graphics card type, graphics card memory, etc. The performance parameters can then be used to configure virtual computing resources to achieve a virtual computer that substantially meets the performance parameters.

Given these familiar performance parameters, a user can determine whether the configured virtual computer is capable of performing a desired task such as running business applications, videoconferencing, gaming, computer-aided design or modeling, or other applications. The user can compare a virtual computing configuration with a standalone dedicated machine and decide whether to purchase the standalone computer or the virtual configuration. Software manufacturers, computer manufacturers, third-party add-on hardware developers, and others often report the system requirements needed in order to use their products. These requirements are reported in terms of a dedicated standalone system. Thus, by characterizing the virtual computer configuration in terms that are familiar to a user and in general use in the marketplace, a user will likely be better able to design, purchase and use virtual computing resources.

A method for configuring virtual computing resources, the method comprising: displaying multiple standalone computing resources for selection by a user; accepting a signal from a user input device to select two or more of the multiple standalone computing resources; configuring the virtual computing resources in order to achieve a virtual computer system with a performance that is designed to meet the performance of a standalone computer having the selected two or more of the multiple standalone computing resources; and providing the configured virtual computing resources to a user for use in achieving a function.

Another embodiment provides a method for configuring virtual computing resources, the method comprising: displaying multiple computer descriptions for selection by a user, wherein a computer description includes a stated processor speed; accepting a signal from a user input device to select one of the multiple computer descriptions; configuring the virtual computing resources in order to achieve a virtual computer system that includes a performance designed to meet the stated processor speed of the selected computer description; and providing the virtual computing resources to a user for use in achieving a function.

### BRIEF DESCRIPTION OF THE DRAWINGS

FIG. 1 illustrates basic components in a system suitable for practicing embodiments of the invention;

FIG. 2 shows a first example of screen displays in an interface that allows a user to select and purchase virtual computing resources;

FIG. 3 shows a second example of screen displays in an interface that allows a user to select and purchase virtual computing resources;

FIG. 4 shows a third example of screen displays in an interface that allows a user to select and purchase virtual computing resources;

FIG. 5 shows a fourth example of screen displays in an interface that allows a user to select and purchase virtual computing resources; and

FIG. 6 shows a flowchart that illustrates basic steps to achieve some of the functionality described herein.

### DETAILED DESCRIPTION OF PARTICULAR EMBODIMENTS

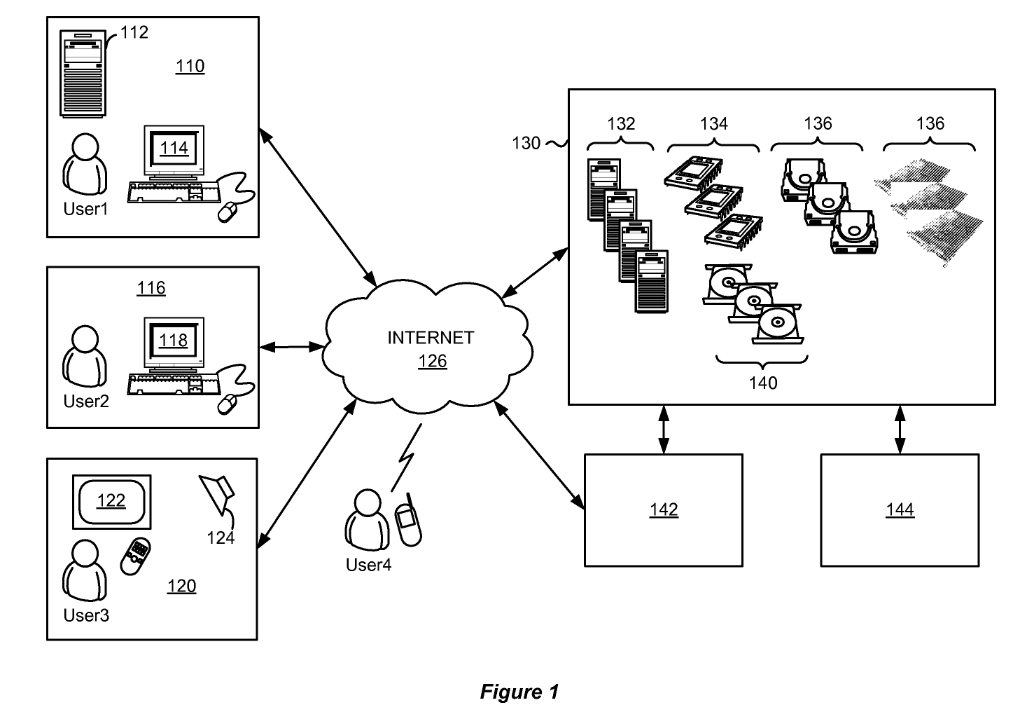

FIG. 1 illustrates basic components in a system suitable for practicing embodiments of the invention. In FIG. 1, User1 is at location 110 where a standalone computer system 112 is dedicated for use by User1. Dedicated resources are those that are essentially completely under the ownership or control of a particular user, or small group of users such as a family, roommates, etc. Standalone computer system 112 typically includes one or more processors, one or more hard disk drives, RAM, a graphics card, an optical media player/writer, etc. User input devices such as a keyboard, mouse, trackball, etc. are associated with the standalone system as are output devices such as display 114, audio speakers (not shown), etc. A standalone system is typically characterized as one in which the components or resources are included within, or in close proximity (i.e., “local”), to a central processor. The RAM and any associated processors are typically coupled to the processor by a bus on a same motherboard as the processor. However, other arrangements are possible that provide a high-speed transfer rate while allowing one or more host processors to control the standalone computer resource use.

In some cases a standalone system may include components that are not immediately proximate to the main housing (or “tower”) that includes a host processor. For example, a standalone computer system may be sold with a high-definition display for watching movies streamed over the Internet. The high-definition display might be separated by one or more rooms in a house from the main housing. Also, storage devices such as an external hard disk drive, optical media “jukebox” or other devices that are controlled by the host processor can be considered part of the standalone system.

Resources are considered “dedicated” to a user or to a group of users or to a specific task if essentially all of the resources of the system are under the ownership or control of a single person or entity to be used for that person or entity's tasks. A dedicated system can include one or more standalone systems. Or it can include discrete components that are either local or separate from each other and from the owner.

Resources are considered “virtual” if they can be allocated or configured for different users, entities or tasks on a paid basis. For example, FIG. 1 illustrates an external remote location 130 that includes many sets of standalone computers 132. For ease of illustration only a few are shown but a virtual computing installation may have hundreds or more such systems, each of which (or a portion of which) may be configured and allocated to a particular user or entity or task for a period of time in return for payment.

Other types of virtual computing resources can be maintained external to any standalone computing system. FIG. 1 shows processors at 134. These may be on motherboards or other infrastructure and coupled to other resources by a local network or a global network such as the Internet. Similarly, other resources such as disk drives 136, graphics accelerators 138 and optical media 140 can exist as virtual computing resources, as desired. An operator of a virtual computing resource installation can maintain a large amount of various types of hardware, as desired.

Optical media 140 (or other media) can be used to store operating system software, applications, utilities or other software, as desired. The software itself can be another type of virtual computing resource that can be purchased by a user and configured as part of a virtual computing system. Any other type of computing resource, either presently known or later developed, may be provided as a virtual computing resource that can be selected and configured according to the description herein. Additional installations such as 142 and 144 may be used to provide yet more virtual computing resources.

Location 116 of FIG. 1 illustrates User2 operating a computing system with virtual computing resources. In a virtual computing application it is not necessary to have a standalone computer (or any computer) local to the user or dedicated to a user or a user's tasks. In this case, location 116 is shown provided only with an output device such as display 116 and user input devices such as a mouse and keyboard. Naturally, other arrangements of hardware can be used to achieve virtual computing. For example, a standalone computer, or local computer resources, can be used in addition to virtual computing resources.

Location 120 of FIG. 1 shows an application where virtual computing resources are being used to achieve a home theater application. In this case a user input device can be an entertainment center remote control. Display 122 and audio output 124 are controlled by virtual computing resources provided over a large-scale network such as the Internet. Although embodiments of the invention are discussed with reference to the Internet, it should be apparent that any other modes of communication may be suitable for the data transmission functions described herein. Also, any number or type of input/output arrangements or devices may be adapted for use with the functionality described herein. For example, User4 is shown with a cell phone which may be capable of selecting and using virtual computing resources. Other devices that can be used include television displays, set-top boxes, portable computers, game consoles, audio players, etc.

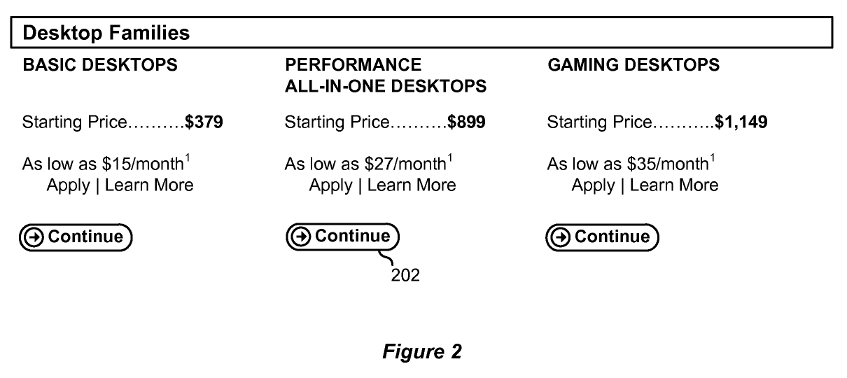

FIGS. 2-5 provide examples of screen displays in an interface that allows a user to select and purchase virtual computing resources in a manner analogous to that of configuring and purchasing a standalone computer system.

FIG. 2 shows a first portion of a screen display for allowing a user to select a general type, or “family,” of computing performance. In FIG. 2, three different types of desktop computer are shown: a “basic” computer, a “performance” computer and a “gaming” computer. The performance parameters for each of the types of systems is typically progressively greater for each family. That is, the “basic” computer system could have a slower processor, less memory and smaller hard disk drive than the “performance” system. The performance system, in turn, would have less memory, drive capacity and processor speed than the gaming system. Other types or families of systems are possible. Although standalone desktop computers are used here as an example, it should be apparent that many different types of computer systems can be used in a similar manner. For example, laptops, ultra-portable computers, home entertainment systems, etc. can be used as starting points for configuring computing resources.

A starting price for each system type is shown. The basic computer system starts at $379, for example. The user can select any one of the systems to continue with performance parameter selections by clicking on the “Continue” button associated with each system type. Also provided are pay-by-month terms which, if clicked, provide details of payments over time. The user can “apply” for the pay-by-month credit terms and can also “learn more” about different payment options by clicking the respective text. Additional ways to purchase resources can be included at this selection screen or on any subsequent screen. For example, since the computing resources are provided from a pool of larger resources, the user may only wish to have the resources at a specific time of day, for a given time period (e.g., one month, one day), to perform a specific task (e.g., process a large digital image, watch a movie), or for other purposes which can be measured and charged according to length of time, type of task, amount of resource utilization or other factors.

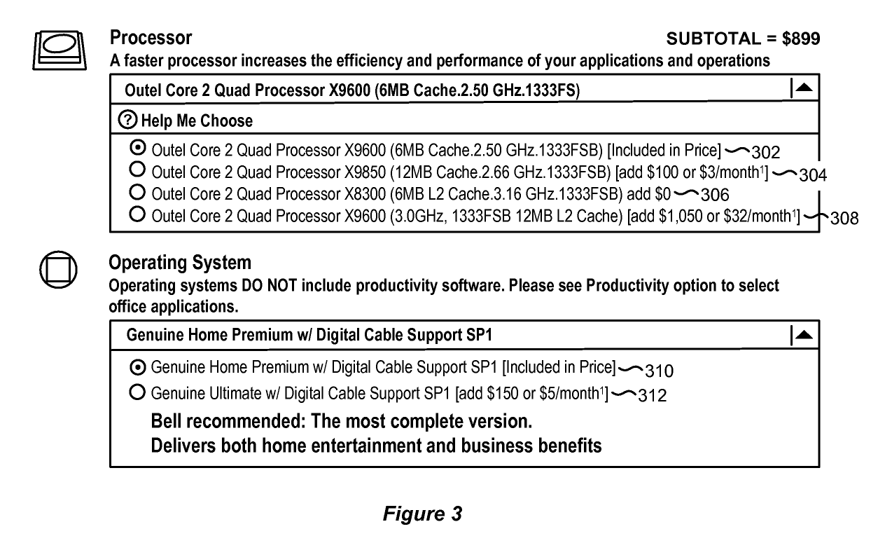

FIG. 3 shows a portion of a screen display after the performance system of FIG. 2 has been selected by the user clicking on “continue” button 202. In FIG. 3, performance parameters for the processor speed and operating system type can be selected. As shown at the top of the screen display, the running subtotal of “$899” is dislplayed.

By using the radio buttons to the left of the text the user can select any of 4 different processor options. The currently selected option is 302 which is the default processor type and speed included in the currently displayed price. By selecting a different radio button, performance parameter 304 can be chosen at an increase to the subtotal (and ultimate purchase price) of $100 (or, $3/month). Option 306 provides different selectable processor performance parameters but does not change the current price. Option 308 provides a very fast processor with improved performance parameters and a price increase over the current price of $1050 or $32/month. Any other processor performance parameters can be used including any one or more of clock speed, processor type, number of processors, size or processor cache or other associated memory, etc.

Note that the appearance to a purchaser can be that of selecting a single processor package for a standalone system. This is a familiar procedure to many buyers and since these types of processor packages are used by several different computer system manufacturers they also provide a good benchmark for overall performance of a system, including a virtual computing system. Embodiments of the invention use the selected performance parameters to allocate or configure virtual computing resources to achieve the overall performance of a standalone system that would use the selected processor package. In this manner, a user/buyer is able to have a frame of reference for the value of the purchased virtual computing resources and also to make other decisions such as cost vs. performance tradeoffs, designing a system adequate for a specific purpose, etc.

At the bottom of the screen display of FIG. 3 are items performance parameters 310 and 312 for selecting an operating system for the virtual system. Other types of software can be provided such as office productivity programs, games, anti-virus utilities, or any other applications, operating systems or software.

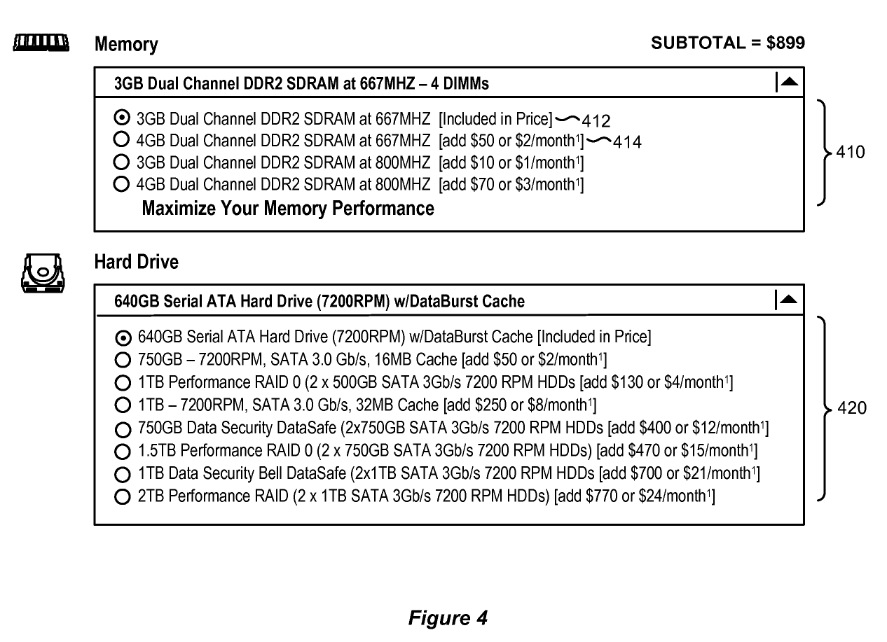

FIG. 4 shows performance parameter selections for RAM at 410. Selection 412 is the current selection as indicated by the shaded-in radio button to the left of the selection. In a preferred embodiment, each selection is exclusive of the others so that selecting an unselected option, such as 414, causes the current selection to change from 410 to 412 so that selection 410's radio button becomes unshaded and selection 412's radio button becomes shaded. More importantly, choosing selection 414 also causes the price subtotal to update to show an increase of $50 and the selected performance parameter will be used to configure virtual computing resources when the selection process is completed. Other embodiments can allow multiple selections of a type of performance parameter such as RAM and these multiple selections can be accumulated for a final selection.

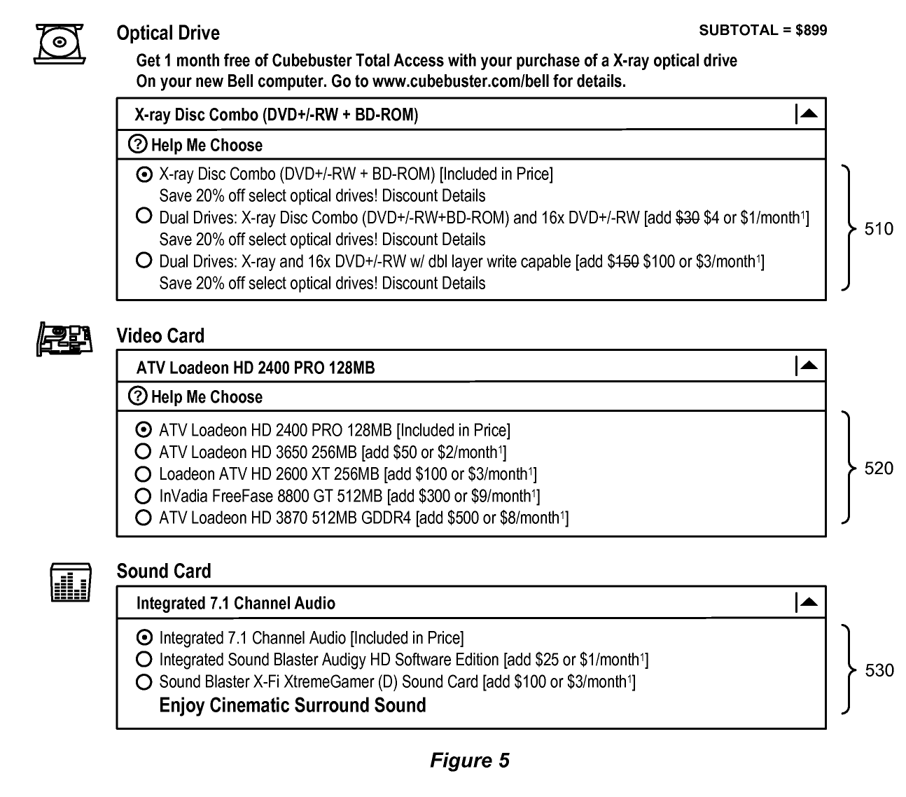

Also shown in FIG. 4 are the available performance parameter selections for a hard disk drive at 420. Various combinations of sizes, speeds and types of hard disk drives can be selected. Each of these selections can result in an overall system (either physical or virtual) with different overall performance that is dependent, in part, on the hard disk drive selection. Similarly, FIG. 5 shows selections for an optical drive at 510, selections for a video card at 520, and selections for an audio card at 530.

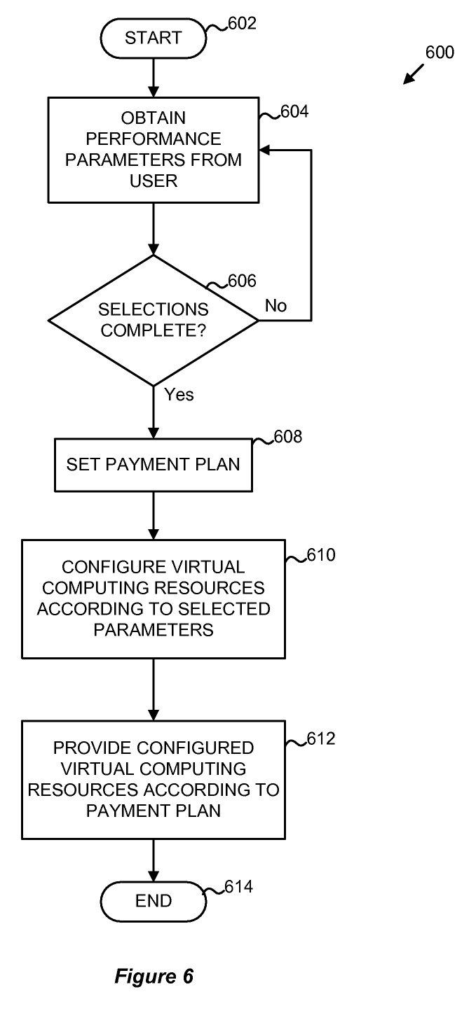

FIG. 6 shows a flowchart that illustrates basic steps to achieve some of the functionality described herein. In FIG. 6, flowchart 600 is entered at step 602 when a user desires to configure virtual computing resources. At step 604 performance parameters are obtained by presenting various selections to the user such as by using one or more screens along the lines of those in FIGS. 2-5. Note that various embodiments can combine the use of standalone computer characteristics with other ways to describe selections. The particular presentation format and design can vary, as can the manner of user selection. For example, a slider control can be used to continuously vary a parameter's value, such as processor speed, memory capacity, etc. User selection of a parameter can be by any suitable user input control including voice recognition, image or gesture detection, etc.

At step 606 a check is made whether there are more selections to be obtained from the user. If so, step 604 is repeated until all selections are made. A preferred embodiment is designed so that a user can choose a baseline system as discussed in connection with FIG. 2. After choosing the baseline system the user can choose to exit the selection process. Or the user can continue to customize the system by performing additional selections such as described in FIGS. 3-5.

After user selections are completed, step 608 is performed to set a payment plan for a computer system that is configured according to the selected resources. Note that the steps of flowchart 600 need not be performed in the specific order shown in the flowchart. For example, a payment plan can be set prior to selection of all performance parameters. Or a payment plan can be formed as the selection process moves along, as described above where the subtotal price is updated upon each selection. In general, embodiments may deviate from those described herein including steps being added to, deleted from, or modified from those shown in the flowchart.

Once a payment plan is set at step 608, execution proceeds to step 610 where virtual computing resources are configured according to the selected performance parameters. Such configuration can be done automatically or manually or by a combination of automatic and manual steps, as desired. Examples of virtual computing systems and management of virtual computing resources may be found in the patent applications referenced above. Any other suitable approaches to virtual computing configuration and control can also be used.

Next, step 612 is performed to provide the virtual computing resources to a user according to the payment plan. The routine exits at step 614.

Although specific embodiments of the invention have been described, variations of such embodiments are possible and are within the scope of the invention. For example, although embodiments of the invention have been described primarily with respect to virtual computing resources, the selected performance parameters can be used to configure a system that is a combination of physical and virtual computing resources.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “sand/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for configuring virtual computing resources, the method comprising:
displaying multiple performance parameters for a standalone computer system, wherein a performance parameter includes a processor characteristic;
accepting a signal from a user input device to select one of the performance parameters;
configuring the virtual computing resources in order to achieve a virtual computer system designed to meet the processor characteristic of the selected performance parameter; and
providing the virtual computing resources to a user for use in achieving a function.

2. The method of claim 1, wherein a performance parameter includes a clock speed.

3. The method of claim 1, wherein a performance parameter includes a processor brand name.

4. The method of claim 1, wherein a performance parameter includes multiple processor cores.

5. The method of claim 1, wherein a performance parameter includes execution time of a benchmark test.

6. The method of claim 1, wherein a computer description includes a number of operations per unit interval.

7. The method of claim 1, further comprising:
displaying resource parameters for one or more of the virtual computing resources, wherein a resource parameter includes one or more of (1) memory size, (2) hard disk drive capacity, (3) bus speed, (4) graphics acceleration.

8. The method of claim 1, further comprising:
charging a user based on the configured virtual computing resources.

9. The method of claim 8, further comprising:
charging the user based on the time duration for which the configured virtual computing resources are made available to the user.

10. The method of claim 1, further comprising:
displaying a price in association with each of the multiple computer descriptions; and
charging a user an amount in correspondence with the price associated with the selected computer description.

11. A method for configuring virtual computing resources, the method comprising:
displaying multiple standalone computer performance parameters for selection by a user;
accepting a signal from a user input device to select two or more of the performance parameters;
configuring the virtual computing resources in order to achieve a virtual computer system designed to meet the selected performance parameters; and
providing the configured virtual computing resources to a user for use in achieving a function.

12. The method of claim 11, wherein a performance parameter includes processor performance.

13. The method of claim 11, wherein a performance parameter includes storage capacity.

14. The method of claim 11, wherein a performance parameter includes transmission speed.

15. The method of claim 11, further comprising:
displaying a purchase price for use of configured virtual computing resources that are designed to meet the performance of a standalone computer having the selected performance parameters.

16. The method of claim 15, further comprising:
charging for the configured virtual computing resources in accordance with the displayed purchase price.

17. The method of claim 16, wherein the charging is based on one or more of the following: a one-time payment, a payment over time, use of the configured virtual computing resources over time, use of the configured virtual computing resources per task.

18. The method of claim 11, further comprising:
accepting a signal from a user input device to select an application;
automatically selecting virtual computing resources in order to optimize execution of the selected application by using the selected virtual computing resources.

19. An apparatus for configuring virtual computing resources, the apparatus comprising:
a processor;
a processor-readable storage device including instructions executable by the processor for:
displaying multiple standalone computer performance parameters for selection by a user;
accepting a signal from a user input device to select two or more of the performance parameters;
configuring the virtual computing resources in order to achieve a virtual computer system designed to meet the selected performance parameters; and
providing the configured virtual computing resources to a user for use in achieving a function.

20. A processor-readable storage device including one or more instructions executable by a processor for:
displaying multiple standalone computer performance parameters for selection by a user;
accepting a signal from a user input device to select two or more of the performance parameters;
configuring the virtual computing resources in order to achieve a virtual computer system designed to meet the selected performance parameters; and
providing the configured virtual computing resources to a user for use in achieving a function.
